(19) United States
(12) Patent Application Publication
(10) Pub. No.: US 2022/0128670 A1
(43) Pub. Date: Apr. 28, 2022

(54) SENSOR DEVICE INCLUDING A SENSOR ELEMENT AND A COVER PANEL

(71) Applicant: Robert Bosch GmbH, Stuttgart (DE)

(72) Inventor: Manuel Trierweiler, Stuttgart (DE)

(21) Appl. No.: 17/429,762

(22) PCT Filed: Mar. 5, 2020
(86) PCT No.: PCT/EP2020/055768

§ 371 Date: Aug. 10, 2021

(30) Foreign Application Priority Data
Mar. 11, 2019 (DE) 102019203230.3

(51) Int. Cl. G01S 7/497; G01S 7/481; G01S 17/02

(52) U.S. Cl. CPC G01S 7/497; G01S 2007/4977; G01S 17/02; G01S 7/4813

(57) ABSTRACT

A sensor device including a sensor element, a cover panel, and a detection device detecting contaminants on the cover panel. The detection device includes an emitter emitting light, a coupling-in device coupling light into the cover panel, a decoupling device decoupling light from the cover panel, and a detector. The emitter and the coupling-in device couple light into the cover panel at a plurality of angles, and due to total reflection within the cover panel, the light propagates to the decoupling device and reaches the detector. If contaminants are on the cover panel, the total reflection for light coupled in at an angle within an extinction range is at least partially extinguished, and the detector is configured to detect the extinguishing of the total reflection for these angles. The detection device is configured to deduce the type of contaminant from the angles for which the total reflection has been extinguished.

### FIELD

The present invention relates to a sensor device including a sensor element, a cover panel that protects the sensor element from environmental influences, and a detection device for detecting contaminants on the cover panel.

### BACKGROUND INFORMATION

Sensor devices such as cameras or LIDAR sensors, which are often used in conjunction with modern vehicles, include a sensor element that is covered with a cover panel for protection from influences from the environment. To ensure the functionality of this sensor device, it is necessary to detect soiling, for example solid particles, water, snow, ice, or oil, on the cover panel. In conjunction with vehicles, rain sensors are known which detect moisture or contaminants in general on a windshield, and which on this basis may optionally activate a windshield wiper. However, a characterization of the type of contaminant on the windshield is not possible with these rain sensors.

An optoelectronic sensor, including a transparent protective panel, for monitoring a monitoring area is described in German Patent Application No. DE 10 2007 003 023 B4. To check the light transmission of the protective panel, a test light transmitter is used to irradiate test light into the interior of the protective panel, an angle of incidence being selected in such a way that total reflection occurs. The interior of the protective panel is thus illuminated, but light cannot exit from the surfaces of the protective panel and reach an image sensor of the optoelectronic sensor. If the protective panel is soiled at a location, the conditions for total reflection are no longer met at this location, and light may exit and be detected as interfering light by the image sensor. As an alternative to an image sensor, a photodiode, via which the test light level is determined, may be situated opposite from the test light transmitter. For a clean panel, a known test light level is received. This level changes when test light can exit from the panel due to soiling.

A method and a device for registering and analyzing clear liquids on a transparent panel are described in German Patent No. DE 23 54 100 A1. Light is deflected onto the panel via an optical system in such a way that the light strikes the panel at an angle of the total reflection. The totally reflected light exits the panel through a prism plate and is focused onto a detector by an optical system. If various materials such as oil and water, having different refractive indices, are situated on the panel, a different critical angle of the total reflection with regard to the panel material is also to be associated with these materials in each case. It is thus possible to distinguish liquids based on their different refractive indices, so that in a panel washing facility, for example, different cleaning agents may be used.

A cooking appliance with a cooking chamber that includes an optical soiling sensor is described in German Patent Application No. DE 10 2014 116 709 A1. The soiling sensor includes a transparent sensor surface, a light source, and a light sensor. The sensor surface is part of a cooking chamber wall, and the light source and the light sensor are situated outside the cooking chamber in such a way that light from the light source strikes the sensor surface obliquely, and light that is reflected from the sensor surface is received by the light sensor. Due to soiling on the transparent sensor surface, the refractive index is changed in such a way that, at least for a portion of the light emitted from the light source, the total reflection at the sensor surface is eliminated. Since the incident light is preferably coupled into the sensor surface over a broad angular range, the decoupling is also provided over an angular range that extends up to the total reflection at the transparent sensor surface. The decoupling angle is determined by the optical refractive property of the soiling material, as the result of which, via the angular range of the extinguished total reflection, it is even possible to determine the refractive index of the soiling material. In turn, this property may be used to deduce the type of soiling material.

The use of cleaning devices in conjunction with sensor devices that include a sensor element and a cover panel that protects the sensor element from environmental influences is available in the related art. Thus, German Patent Application No. DE 10 2018 104 007 A1 describes a device that includes a sensor containing a cylindrical window, and a wiper blade that is fastened to the sensor and is movable over a viewing portion.

Due to wear, these types of cleaning systems cannot operate continuously. It is therefore desirable to detect whether, and if so which, contaminants are present on a cover panel of a sensor device.

### SUMMARY

In accordance with an example embodiment of the present invention, a sensor device that includes a sensor element, a cover panel that protects the sensor element from environmental influences, and a detection device for detecting contaminants on the cover panel is provided. The detection device includes an emitter for emitting light, coupling-in means (a coupling-in device) for coupling light into the cover panel, decoupling means (i.e., a decoupling device) for decoupling light from the cover panel, and a detector. In accordance with an example embodiment of the present invention, it is provided that the emitter and the coupling-in means are designed and arranged in such a way that light is coupled into the cover panel at a plurality of angles, and due to total reflection within the cover panel is propagated up to the decoupling means and reaches the detector. If contaminants are present on the cover panel, the total reflection for light that has been coupled in at an angle within an extinction range, which is a function of the refractive index of the contaminants, is at least partially extinguished. The detector is configured to detect the extinguishing of the total reflection for these angles, and the detection device is configured to deduce the type of contaminant from the angles for which the total reflection has been extinguished.

The sensor device may use the information concerning the type of contaminant to make an assessment of the functional capability of the sensor device, or an assessment of the quality of the information detected by the sensor element, and optionally to take countermeasures.

The sensor element is a device that uses electromagnetic radiation such as light or radio waves to detect data about the surroundings of the sensor device. For protection from environmental influences, this sensor element is protected with a cover panel that is transparent to the electromagnetic radiation used by the sensor element. If the sensor element operates using light, for example, the cover panel is permeable to light. However, if contaminants such as water or other soiling are present on the cover panel, the propagation of the electromagnetic radiation through the cover panel may be disturbed, so that the functioning of the sensor element is also impaired or at least limited. In addition to the cover panel, the sensor device may include further housing parts, which do not absolutely have to be transparent to the used electromagnetic radiation of the sensor element.

In accordance with an example embodiment of the present invention, the detection device of the sensor device is configured to not only register the presence of contaminants, but also to determine the type of contaminants involved. Light is coupled into the cover panel in order to detect the contaminant and its type. The light is emitted by the emitter and coupled into the cover panel, using the coupling-in means. The light is coupled into the cover panel at a plurality of angles. A plurality of angles may be understood to mean multiple discrete light beams, it being possible to associate a different angle with each of these light beams; however, this may also involve a continuous angular range, for example, over which light is coupled into the cover panel. This continuous angular range is delimited by a largest angle and a smallest angle at which light is coupled into the cover panel and propagated within the cover panel, utilizing the total reflection.

The light coupled into the cover panel is repeatedly totally reflected between two surfaces of the cover panel, and in this way propagates from the location at which the light has been coupled into the cover panel to a location at which the light is decoupled. The coupling-in means are situated opposite from or adjacent to the location at which the light is coupled into the cover panel, and the decoupling means are correspondingly situated adjacent to or opposite from the location at which the light is decoupled from the cover panel.

The light that is decoupled from the cover panel, using the decoupling means, leaves the decoupling means in each case at different angles, each of which corresponds to an angle at which light has been coupled into the cover panel. The decoupled light is registered via the detector, the detector being able to distinguish between different angles. Depending on the design of the detector, it may distinguish between a different number of angular ranges.

If the cover panel is free of soiling, light may pass from the coupling-in location to the decoupling location at each of the coupled-in angles, so that light is registered by the detector for all angular ranges. For all coupled-in angles, the light is totally reflected in each case at an interface between the cover panel and the surrounding air.

In contrast, if the cover panel has soiling, a changed condition is present at least at the soiled areas. At the position at which a contaminant is situated, the refractive index of the cover panel changes, not to the refractive index of air, but, rather, to the refractive index of the particular material of the soiling. Depending on the value of the refractive index of the material of the soiling, for certain angles at which light has been coupled into the cover panel, the conditions for a total reflection are thus no longer met, so that for these angles at least a portion of the light from the cover panel is already decoupled from the cover panel at the location of the soiling. According to the Fresnel equations, all beams that have been coupled into the cover panel at an angle that is smaller than the critical angle of the total reflection at least partially decouple from the cover panel. For contaminants having a small refractive index, the critical angle of the total reflection is smaller than for a contaminant having a large refractive index. For this reason, for a contaminant having a fairly large refractive index, the propagation of light within a cover panel for a fairly large angular range has greater loss compared to a contaminant having a smaller refractive index. The partial decoupling of light is subsequently registered by the detector, for certain angular ranges the detector detecting the at least partially extinguished total reflection via a decrease in the registered intensity of the light.

In accordance with an example embodiment of the present invention, the emitter is preferably configured to emit light in the form of a divergent light beam. All propagation angles within the cone predefined by the divergent light beam are contained in this divergent light beam. Thus, by coupling this divergent light beam into the cover panel, light is also coupled into the cover panel in a continuous range of angles, and then propagates utilizing the total reflection within the cover panel.

The emitter is preferably designed as a light-emitting diode or as a laser diode.

The light emitted by the emitter may have a certain wavelength or a certain wavelength range. The wavelength of the light emitted by the emitter is preferably selected in such a way that it has no influence or as little influence as possible on a measurement by the sensor element of the sensor device. For example, for this purpose a wavelength may be selected for which the sensor element has no or only slight sensitivity. Alternatively or additionally, it may be provided to insert a filter element that is situated upstream from the sensor element and that suppresses light emitted by the emitter.

The coupling-in means and/or the decoupling means are preferably designed as a prism, as a hologram, as an optical lattice, or as a beveled surface of the cover panel. In the case of a beveled surface of the cover panel, this surface is situated in relation to the emitter or to the detector in such a way that it is not situated perpendicularly with respect to an axis of the emitter or of the detector, but rather, extends at an angle.

For the case that the coupling-in means or the decoupling means are designed as a prism, as a hologram, or as an optical lattice, these means may be designed as an additional element that is situated adjacent to or opposite from the cover panel. Alternatively, these coupling-in means or decoupling means may also be integrated directly into the cover panel.

For detecting contaminants on the cover panel, it is necessary for the area of the cover panel in question, on which contaminants are to be detected, to be situated on a region of the cover panel beneath which light propagates from the emitter to the detector. To be able to cover the largest possible area of the cover panel, it is preferred that the detection device includes multiple spatially distributed emitters and/or detectors. By providing multiple emitters, and correspondingly, multiple detectors that are associated with the particular emitters, light may be coupled in at multiple locations of the cover panel, and correspondingly decoupled at multiple locations. Light thus propagates via various paths, starting from an emitter to one of the detectors, the various paths being arranged in such a way that it is possible to check at least the surface of the cover panel, required by the sensor element, for contaminants. The area of the cover panel required by the sensor element means that portion of the cover panel through which the sensor emits electromagnetic radiation or through which the sensor element receives electromagnetic radiation. Alternatively or additionally, it may be provided to place at least one first optical element, such as a diffuser or a lens, between an emitter and a coupling-in means in order to influence the light prior to the coupling-in. For example, the light emitted by the emitter may be distributed over a defined surface via a diffuser.

Additionally or alternatively, it may also be provided that at least one emitter and at least one detector are movably accommodated in the detection device, so that the area in which contaminants may be detected on the cover panel may be varied by changing the position of the emitter or of the detector. For this purpose, a translational or rotational motion of the emitter and/or detector preferably takes place.

In one embodiment variant of the sensor device in accordance with the present invention, the cover panel is designed in the form of a circular cylinder having a cylinder axis. The at least one detector and the at least one emitter are configured to rotate about the cylinder axis. In this way, the detection device may monitor at least a portion of the circumferential surface of the circular cylinder via an emitter and an associated detector.

The sensor element is preferably a LIDAR sensor or a video camera. However, the sensor element may be an arbitrary light-sensitive sensor. In the case of a LIDAR sensor, when a sensor device including a cover panel having a circular cylindrical shape is selected and used for detecting contaminants on the cover panel, it is preferred to use a detector that includes at least one emitter and one detector that are configured to rotate about the cylinder axis of the circular cylindrical shape of the cover panel. It may be provided in particular that portions of the LIDAR sensor as well as the emitter and the detector are situated together on a rotating unit.

The detector of the detection device is preferably designed as a charge-coupled device (CCD) or as an array of photodiodes. In the case of an array of photodiodes, each of the photodiodes corresponds to an angular range that may be detected by the detector. In the case of a CCD, the detector includes a large number of pixels, each of which may detect the intensity of light at a different position, an angle or a small angular range being associated with each pixel of the CCD. Alternatively, it is possible for the detector to include other detector elements that are sensitive to optical radiation. In this case as well, in each case a detector element is provided for detecting light intensity for a certain angular range.

In addition, the radiation decoupled by the decoupling means may be influenced via at least one second optical element, such as a lens, in such a way that beams having the same angle are imaged on the same detector position in order to increase the measuring accuracy.

In accordance with an example embodiment of the present invention, the sensor device preferably also includes a cleaning device for cleaning the cover panel. This cleaning device is preferably configured to be operated as a function of the type and/or quantity of contaminants that have been detected on the cover panel. Thus, on the one hand it is possible for the cleaning device to be activated only when any contaminants at all are detected, and completely deactivated when no contaminants are detected on the cover panel. On the other hand, it may be provided that an operating mode of the cleaning device is selected as a function of the type of detected contaminant.

The cleaning device preferably includes a spray device for applying a liquid to the cover panel, the cleaning device being configured to activate the spray device as a function of the type of contaminant. Thus, for example, it may be provided that if water is detected on the cover panel, no additional liquid is applied, and therefore the cleaning device is activated without activating the spray device. Conversely, it is preferably provided that when dry contaminants are detected, the spray device is activated to wet the cover panel or facilitate removal of the contaminants.

For the removal of contaminants, the cleaning device may in particular include a mechanical cleaning unit such as a mechanical wiper blade. To avoid premature wear of this wiper blade, it is preferably provided that dry operation of the wiper blade is avoided. This means that when dry contaminants are detected, the wiper blade is operated solely in combination with a spray device. Conversely, when moisture is detected on the cover panel, the wiper blade may also be operated without activating the spray device.

The liquid that is applied using the spray device may in particular be a cleaning fluid. For example, for this purpose water may be added to a cleaning agent.

The cleaning device may be configured to store multiple various liquids and apply them to the cover panel in a targeted manner. The cover panel is preferably manufactured from a material that is transparent to the electromagnetic radiation that is received or emitted by the sensor element. In particular, a plastic or a glass that is transparent to the areas of the electromagnetic spectrum in question may be used for the material for the cover panel.

In accordance with the present invention, by use of the detection device, the provided sensor device may detect the type of contaminants that are present on the cover panel which protects a sensor element of the sensor device from environmental influences. It is thus possible to assess whether the sensor device is functional, i.e., whether or not the sensor element of the sensor device is able to deliver correct data. This is advantageous in particular when the sensor device is used in safety-critical applications, such as the detection of the surroundings during operation of an autonomous vehicle. The ability to distinguish between various types of contaminants is important, since not every contaminant impairs the functioning of the sensor element to the same degree.

In addition, with knowledge of the type of contaminants on the cover panel, it is possible to initiate countermeasures in a targeted manner. In preferred specific embodiments of the present invention, for this purpose the sensor device includes a cleaning device that is operated as a function of what type of contaminants have been detected. For example, if liquids are detected, a wiper blade may be activated without the need to spray on a cleaning fluid beforehand, using a spray device. Conversely, when dry contaminants are present, the wiper blades may be prevented from operating dry, and a cleaning fluid may be sprayed on beforehand.

Furthermore, it is possible, depending on the type of contaminant detected, to select a different cleaning method and/or a different cleaning fluid in each case in order to remove the contaminants.

Due to the coupling-in of large angular ranges into the protective cover, it is possible for the detection device to detect contaminants on the entire surface of the cover panel. At the same time, a measure for the degree of soiling may be determined by the detection device, thus allowing a meaningful interpretation of the measured data of the sensor device.

In addition, the wavelength of the used radiation of the detection device is freely selectable. This wavelength may thus be selected in such a way that interfering influences due to background light are minimized. Further minimization of the interference effects may be achieved by adding filters.

### BRIEF DESCRIPTION OF THE DRAWINGS

Exemplary embodiments of the present invention are described in greater detail based on the figures and the description below.

FIG. 1 shows a schematic illustration of a sensor device, including a detection device for detecting contaminants on a cover panel, in accordance with an example embodiment of the present invention.

FIG. 2 shows a schematic illustration of the measuring principle.

FIGS. 3a and 3b show a schematic illustration of the propagation of three different light beams without contaminants.

FIGS. 4a and 4b show schematic propagation of three light beams when a first contaminant is present.

FIGS. 5a and 5b show the propagation of three light beams when a second contaminant is present.

FIG. 6 shows a sensor device including a cylindrical cover panel, in accordance with an example embodiment of the present invention.

### DETAILED DESCRIPTION OF EXAMPLE EMBODIMENTS

In the following description of the specific example embodiments of the present invention, identical or similar elements are denoted by the same reference numeral, and a repeated description of these elements is dispensed with in individual cases. The subject matter of the present invention is illustrated only schematically in the figures.

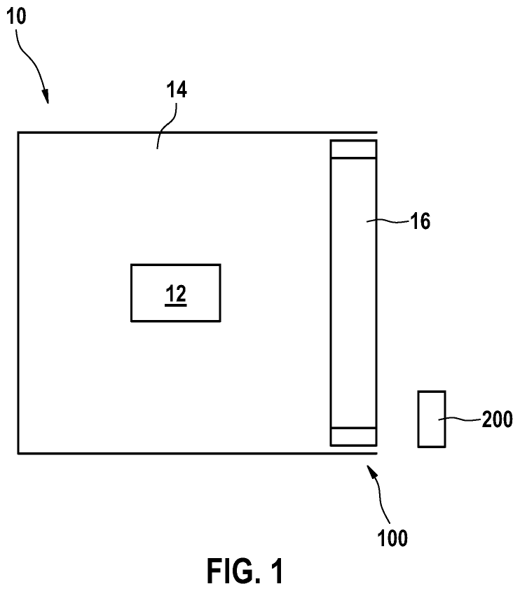

FIG. 1 shows a schematic illustration of a sensor device 10. Sensor device 10 includes a sensor element 12 with which data about the surroundings in which sensor device 10 is situated may be detected. For this purpose, sensor element 12 is configured to receive electromagnetic radiation and optionally also to emit electromagnetic radiation. Sensor element 12 is situated in a housing 14 that is closed by a cover panel 16. Cover panel 16 protects sensor element 12 from environmental influences. At the same time, cover panel 16 allows electromagnetic radiation to reach element 12, and conversely, optionally allows electromagnetic radiation emitted by sensor element 12 to be released into the surroundings.

If sensor element 12 is designed as an optical camera, cover panel 16 is transparent to visible light. If sensor element 12 is an infrared camera, for example, cover panel 16 is transparent to infrared light and optionally may be nontransparent to visible light. A further example of a sensor element 12 is a LIDAR sensor, with which objects in the surroundings of sensor device 10 may be detected and their distance from sensor device 10 may be determined.

Sensor device 10 also includes a detection device 100 for detecting deposits on cover panel 16. In addition, the specific embodiment of sensor device 10 illustrated in FIG. 1 includes a cleaning device 200 via which contaminants 110 may be removed from cover panel 16.

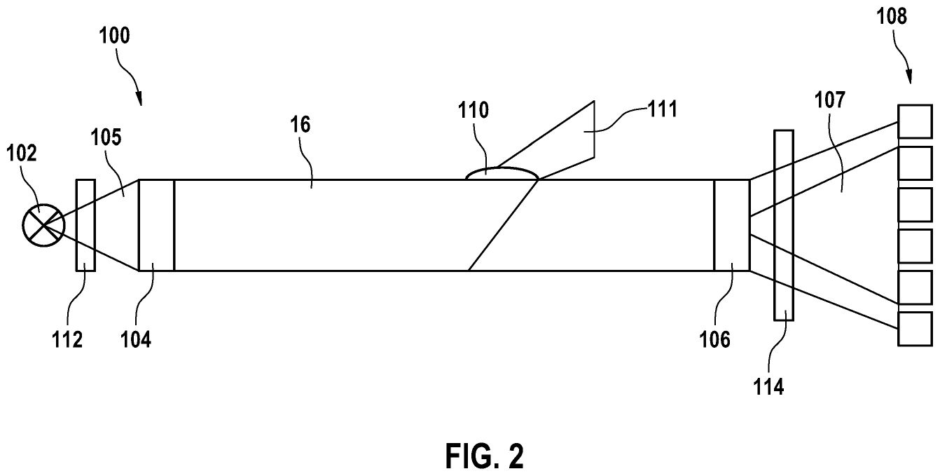

FIG. 2 schematically shows detection device 100 (cf. FIG. 1) via which deposits 110 on a surface of cover panel 16 may be detected. For this purpose, detection device 100 includes an emitter 102 that is designed as a light-emitting diode, for example, and that emits light 105 to be coupled into cover panel 16. Light 105 to be coupled in reaches coupling-in means (i.e., coupling-in device) 104 and is coupled into cover panel 16 by coupling-in means 104. Prior to the coupling-in, light 105 to be coupled in may be influenced by a first optical element 112 situated between emitter 102 and coupling-in means 104. In the example illustrated in FIG. 2, first optical element 112 is designed as a diffuser. The coupled-in light propagates within cover panel 16 in the direction of decoupling means (i.e., decoupling device) 106, and exits there as decoupled light 107. The light propagates within cover panel 16 utilizing the total reflection, the light propagating, from coupling-in means 104 to decoupling means 106, by multiple reflections at the surfaces of cover panel 16. If no contaminants 110 are situated on the surface of cover panel 16, the critical angle determined for the total reflection is specified by the refractive index of the material of cover panel 16 and the refractive index of the surrounding air. However, if a contaminant 110 is situated on the surface of cover panel 16, the critical angle at which total reflection within cover panel 16 is possible is reduced at the location of the contaminant 110, due to the refractive index of contaminant 110, which is different from that of air. The degree of reduction of the critical angle is a function of the refractive index of contaminant 110. Since the total reflection now is no longer possible for all angles at which light 105 to be coupled in has been coupled into cover panel 16, a partial quantity 111 of the light is now decoupled at the position of contaminant 110.

By analyzing decoupled light 107 via a detector 108, it may be determined for which angles the total reflection within cover panel 16 is possible, and for which angles it is not possible. Based on this information, it may be derived whether a contaminant 110 is situated on cover panel 16, and the refractive index of this contaminant 110 may be deduced. Since different substances have different refractive indices, for example water has a refractive index of approximately 1.33 and oil typically has a refractive index in the range of approximately 1.4-1.6, a conclusion regarding the type of contaminant 110 is possible solely via the refractive index. Prior to striking detector 108, decoupled light 107 is advantageously influenced by a second optical element 114, which in the example illustrated in FIG. 2 is designed as a lens.

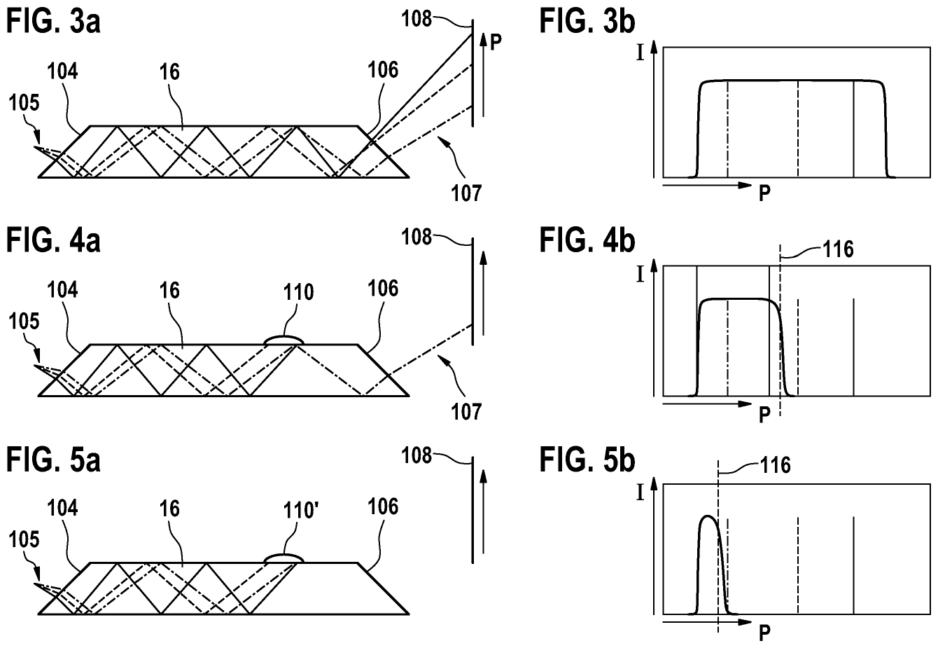

FIG. 3a illustrates the profile of three examples of light beams of light 105 to be coupled in via cover panel 16. Coupling-in means 104 are designed here by way of example as a beveled surface of cover panel 16. Similarly, decoupling means 106 are likewise designed as a beveled surface of cover panel 16.

In the situation illustrated in FIG. 3a, no contaminants 110 (cf. FIG. 2) are situated on cover panel 16, so that total reflection within cover panel 16 is possible for all three depicted beams of light 105 to be coupled in. For decoupled light 107, each of the three beams leaves cover panel 16 at a different angle, so that they strike detector 108 at a different detector position P in each case. Detector position P may be correspondingly associated with a propagation angle in cover panel 16.

FIG. 3b illustrates a diagram that depicts intensity I of decoupled light 107, ascertained by detector 108, as a function of detector position P. As is apparent from the illustration according to FIG. 3b, a high intensity I is measured for all three depicted light beams of decoupled light 107. The smallest angle for which a high intensity I is measured corresponds to the critical angle of the total reflection, which is linked to the refractive index. The position on detector 108 that corresponds to the critical angle is marked by reference numeral 116.

FIG. 4a and associated FIG. 4b illustrate the propagation of the three light beams (cf. FIG. 3a) through cover panel 16, a contaminant 110 being situated on a surface of cover panel 16. Due to the presence of contaminant 110, the critical angle at which total reflection is possible inside cover panel 16 changes at the position of contaminant 110, so that the conditions necessary for the total reflection are met for only one of the three light beams of light 105 to be coupled in. Accordingly, only one of the three depicted light beams in the form of decoupled light 107 reaches detector 108. Similarly, the associated diagram of FIG. 4b shows a high intensity I for only one of the three light beams.

FIG. 5a and associated FIG. 5b show the same situation as in FIGS. 4a and 4b, but for a second contaminant 110′ that has a different refractive index. The refractive index of second contaminant 110′ does not allow a total reflection inside cover panel 16 for any of the three depicted light beams of light 105 to be coupled in, so that of the three depicted light beams, none reach detector 108. Correspondingly, the diagram of intensity I of the light ascertained by detector 108 from FIG. 5b no longer indicates an appreciable intensity I for any of the three depicted light beams. The position on detector 108 that corresponds to the critical angle is once again marked by reference numeral 116.

In the cases illustrated in FIGS. 3a, 4a, and 5a, detector 108 may be designed as a single-line CCD, for example, so that detector 108 may ascertain intensity I of the particular incident light along one spatial dimension for a plurality of pixels. Alternatively, as indicated in FIG. 2, for example, it is possible to design detector 108 in the form of multiple detector elements 109, each of which represents a photodiode, for example, that is sensitive to light. Each of these photodiodes may then correspondingly ascertain light for a certain angular range for which total reflection inside cover panel 16 is possible.

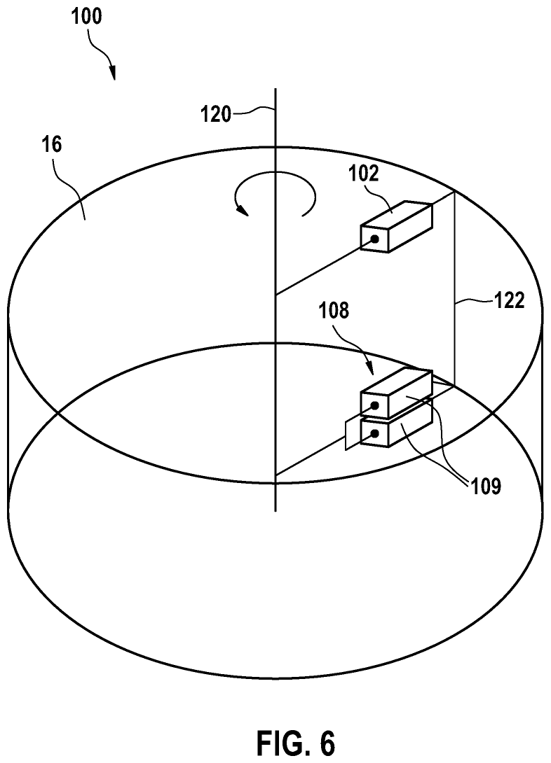

FIG. 6 shows one exemplary embodiment of a detection device 100 in conjunction with a cover panel 16 designed in the form of a circular cylinder having a cylinder axis 120. In this example, detection device 100 includes an emitter 102, and a detector 108 that includes two detector elements 109. Each of the two detector elements 109 may detect light that has been coupled into cover panel 16 over a certain angular range.

To cover the entire circumferential surface of cover panel 16 using detection device 100, emitter 102 and detector 108 are configured in such a way that they may rotate about cylinder axis 120. Due to rotation about cylinder axis 120, a light path 122 between emitter 102 and detector 108 steadily sweeps across the entire circumferential surface of circular cylindrical cover panel 16.

The specific embodiment of detection device 100 illustrated in FIG. 6 is suitable in particular in conjunction with sensor elements 12 that are designed as a LIDAR sensor and that likewise rotate about an axis.

The present invention is not limited to the exemplary embodiments described here and the aspects highlighted therein. Rather, numerous modifications are possible which are within the scope of activities carried out by those skilled in the art, in view of the disclosure herein.

1-10. (canceled)

11. A sensor device, comprising:
a sensor element;
a cover panel that protects the sensor element from environmental influences; and
a detection device configured to detect contaminants on the cover panel, the detection device including an emitter configured to emit light, a coupling-in device configured to couple light into the cover panel, a decoupling device configured to decouple light from the cover panel, and a detector, the emitter and the coupling-in device being configured and arranged in such a way that light is coupled into the cover panel at a plurality of angles, and due to total reflection within the cover panel, the light propagates up to the decoupling device and reaches the detector, and when contaminants are present on the cover panel, the total reflection for light that has been coupled in at angles within an extinction range, which is a function of a refractive index of the contaminants, is at least partially extinguished, the detector being configured to detect the extinguishing of the total reflection for the angles, and the detection device being configured to deduce a type of contaminant from the angles for which the total reflection has been extinguished.

12. The sensor device as recited in claim 11, wherein the emitter is configured to emit light in the form of a divergent light beam.

13. The sensor device as recited in claim 11, wherein the emitter is a light-emitting diode or as a laser diode.

14. The sensor device as recited in claim 11, wherein the coupling-in device and/or the decoupling device is a prism or a hologram or an optical lattice or a beveled surface of the cover panel.

15. The sensor device as recited in claim 11, wherein the detection device includes multiple spatially distributed emitters and/or detectors.

16. The sensor device as recited in claim 11, wherein the detector a CCD or an array of photodiodes.

17. The sensor device as recited in claim 11, further comprising:
a cleaning device configured to clean the cover panel, the cleaning device being operable as a function of the type of contaminant.

18. The sensor device as recited in claim 17, wherein the cleaning device includes a spray device configured to apply a liquid to the cover panel, the cleaning device being configured to activate the spray device as a function of the type of contaminant.

19. The sensor device as recited in claim 11, wherein the cover panel is in the form of a circular cylinder having a cylinder axis, the emitter and the detector being configured to rotate about the cylinder axis.

20. The sensor device as recited in claim 11, wherein the sensor element is a LIDAR sensor or a video camera.
